(19) United States
(12) Patent Application Publication
(10) Pub. No.: US 2025/0045598 A1
(43) Pub. Date: Feb. 6, 2025

(54) SYSTEMS AND METHODS FOR ENHANCING THE PERFORMANCE OF A LARGE LANGUAGE MODEL USING A GENETIC ALGORITHM

(71) Applicant: Idealab Studio, LLC, Pasadena, CA (US)

(72) Inventor: William Tod Gross, Pasadena, CA (US)

(21) Appl. No.: 18/768,371

(22) Filed: Jul. 10, 2024

Related U.S. Application Data
(60) Provisional application No. 63/517,214, filed on Aug. 2, 2023.

(51) Int. Cl. G06N 3/0985; G06N 3/0455

(52) U.S. Cl. CPC G06N 3/0985; G06N 3/0455

(57) ABSTRACT

Systems and methods for providing enhanced large learning models are disclosed. A user query for the large learning model is received from a user device. A fitness function is received. The large language model is used to generate candidate solutions to the user query. The candidate solutions are evaluated using the fitness function. A genetic algorithm is used to generate, based at least in part on the evaluations of candidate solutions, a population of candidate solutions. The population of candidate solutions are evaluated using the fitness function, and based at least in part on the evaluation of the population of candidate solutions, at least a portion of the population of candidate solutions are transmitted to the user device for reproduction via a user device display and/or a speaker.

### BACKGROUND OF THE INVENTION

### Incorporation by Reference to any Priority Applications

Any and all applications for which a foreign or domestic priority claim is identified in the Application Data Sheet as filed with the present application are hereby incorporated by reference under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND

### Field of the Invention

The present disclosure relates to large language models and enhancing the performance thereof.

### Description of the Related Art

Large language models are becoming an increasingly important technology in content and information production. For example, large language models may be configured to perform a variety of language tasks, such as providing answers to questions, summarizing information, generating human-like text, performing text translations, writing scripts and stories, and/or the like.

A large language model is a type of machine learning model that uses vast amounts of data to learn the statistical patterns of language, such as grammar, syntax, and vocabulary. By way of example, a large learning model may utilize neural networks and may be trained using unsupervised learning techniques.

Disadvantageously, large language models (LLMs) may not always provide the desired output, wasting computer resources and user time. LLMs suffer from such deficits because they are based on statistical patterns in language data, and their output is no better than the data the LLMs were trained on. LLMs may also generate inaccurate, nonsensical or irrelevant responses if the input is erroneous, unclear or ambiguous to the LLM. Additionally, large language models are limited by the complexity of the language they are trained on and may struggle with language that is outside of their training data or domain.

Thus, an improved version of large language models is needed to provide more accurate and relevant responses to user queries.

### BRIEF DESCRIPTION OF THE DRAWINGS

While each of the drawing figures illustrates a particular aspect for purposes of illustrating a clear example, other embodiments may omit, add to, reorder, and/or modify any of the elements shown in the drawing figures. For purposes of illustrating clear examples, one or more figures may be described with reference to one or more other figures, but using the particular arrangement illustrated in the one or more other figures is not required in other embodiments.

FIG. 1 illustrates an example networked environment.

FIG. 2 illustrates and example device architecture.

FIG. 3A illustrates an example neural network architecture.

FIG. 3B illustrates an example transformer architecture.

FIG. 4 illustrates an example user interface.

FIG. 5 illustrates an example flow diagram.

### DETAILED DESCRIPTION

As similarly discussed elsewhere herein, large language models (LLMs) are becoming an increasingly important technology in content and information production. For example, large language models may be configured to perform a variety of language tasks, such as providing answers to questions, summarizing information, generating human-like text, performing text translations, writing scripts and stories, and/or the like. LLMs may thus be utilized in many different types of applications, such as chatbots, language processing, and content creation. Examples of large language models include ChatGPT, GPT-4, PaLM, and LaMDA.

As similarly discussed elsewhere herein, a large language model is a type of machine learning model that uses vast amounts of data to learn the statistical patterns of language, such as grammar, syntax, and vocabulary. By way of example, a large learning model may utilize one or more neural networks and may be trained using unsupervised learning techniques.

Disadvantageously, large language models may not always provide the desired output, wasting computer resources and user time. LLMs suffer from such deficits because they are based on statistical patterns in language data, and their output is no better than the data the LLMs were trained on. LLMs may also generate inaccurate, nonsensical or irrelevant responses if the input is erroneous, unclear or ambiguous to the LLM. Additionally, large language models are limited by the complexity of the language they are trained on and may struggle with language that is outside of their training data or domain.

Certain parameters of large language models (sometimes referred to as hyperparameters) are set before training the model and are not learned during the training process. These parameters control the learning process and architecture of the large language model, and greatly affect the model's performance. Hyperparameters are conventionally set through a time consuming and computer resource intensive trial and error process, which often fails to obtain an optimized or sufficiently capable solution.

Example hyperparameters may include some or all of the following:

Learning rate hyperparameter: This hyperparameter controls the step size used to update the model's weights during training. A larger learning rate may lead to faster convergence but may also disadvantageously cause the model to overshoot the optimal weights.

Number of layers hyperparameter: This hyperparameter controls the depth of the LLM and determines the number of layers used to process the input data. A deeper model can capture more complex features but can disadvantageously also lead to overfitting if not properly regularized.

Number of neurons hyperparameter: This hyperparameter controls the width of respective layers and determines the number of neurons used to process the input data. A larger number of neurons can lead to better performance, but it can disadvantageously also increase the model's computational complexity.

Dropout rate hyperparameter: This hyperparameter controls the probability of dropping out a neuron during training to prevent overfitting. A higher dropout rate can lead to better generalization, but it can disadvantageously also decrease the model's performance.

Batch size hyperparameter: This hyperparameter controls the number of samples used in each training batch. A larger batch size can lead to faster convergence but can disadvantageously also increase the memory requirements of the model.

Disclosed herein are techniques for improving the performance and output of large language models using genetic algorithms. For example, a genetic algorithm may be utilized to suggest useful mutations.

Genetic algorithms are particularly useful when the solution space is large and complex, and traditional optimization techniques may not be effective. A genetic algorithm is an optimization algorithm that mimics, at some level, the process of natural selection and genetic evolution that may be used to solve complex optimization problems.

In a genetic algorithm, a population of potential solutions (which may be referred to as individuals) is evaluated and selected for breeding based on their fitness or quality. The fittest individuals are selected as parents for the next generation, and their genetic information is combined through crossover and mutation operations to create new offspring with potentially better fitness.

The process of selection, crossover, and mutation is repeated for multiple generations, creating a new population each time. The goal is that through this iterative process, the population gradually evolves and improves until a satisfactory solution is found or a stopping criteria is met.

The fitness function is an important component of a genetic algorithm as it determines the quality of the solutions generated. The fitness function is a measure of how well the candidate solution performs a given task. In the case of large language models, the fitness function may be the perplexity or the accuracy of the model on a validation set. Perplexity is a measure of how well a language model predicts a given sequence of words. In the context of large language models, perplexity is commonly used as an evaluation metric to measure the quality of the model's output.

If the fitness function is poorly defined or does not accurately reflect the problem's objective, the algorithm may fail to provide a satisfactory solution.

Thus, a difference between large language models and genetic algorithms is that large language models are typically used for natural language processing tasks, such as text generation, while genetic algorithms are used for optimization problems. For example, genetic algorithms can be used to optimize the hyperparameters (such as those discussed herein) of large language models, which can improve LLM output performance.

By way of example, a user may query a large language model to “provide the best techniques to enhance sleep”. The large langue model may be directed to perform multiple attempts at providing a response to the query (e.g., a user specified or default number of attempts, until a fitness function is satisfied, or the like). Optionally, the fitness function is specified by the user. Optionally, the query may be slightly varied by the user or automatically (e.g., “provide the most recommended techniques to enhance sleep”) for a given attempt.

For example, the fitness function may be “Fact check all the large language model answers to the query, and generate a list of the ten techniques to enhance sleep that are most often mentioned and are fully fact checked.” Thus, by way of illustration, the large language model may continue to generate answers until ten fact checked techniques to enhance sleep are identified. The techniques to enhance sleep may then be output (e.g., via text, speech, or otherwise) via a corresponding user interface to the user.

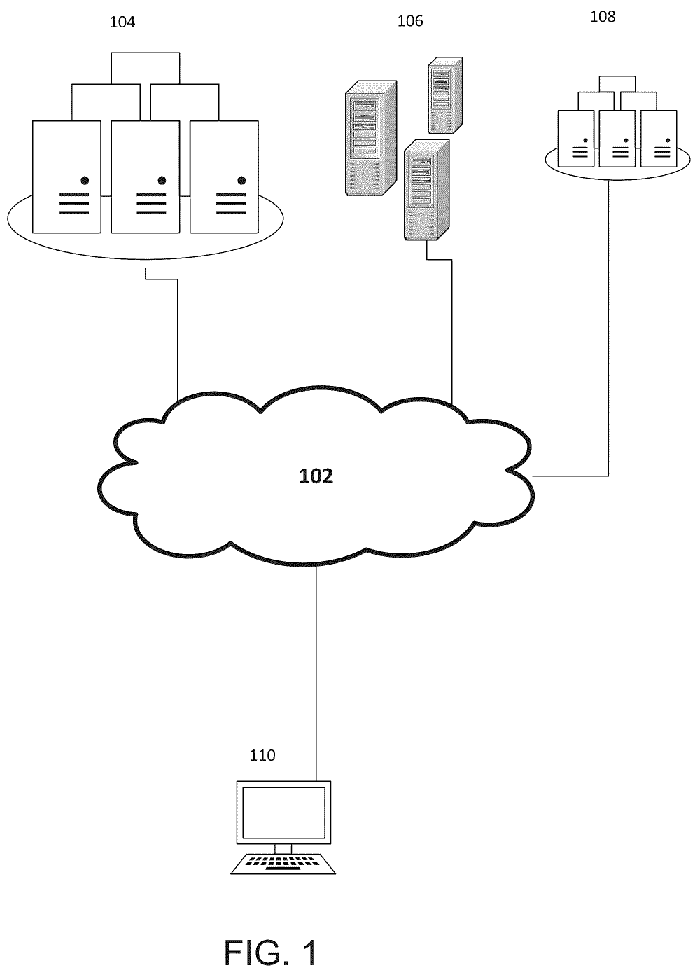

FIG. 1 illustrates an example environment which may be utilized with the methods and systems described herein. An LLM system 104 is configured to generate an LLM. The LLM system 104 may comprise a cloud system. With respect to the cloud-based computer system implementation, the cloud-based computer system may comprise a hosted computing environment that includes a collection of physical computing resources that may be remotely accessible, located at different facilities, and may be rapidly provisioned as needed (sometimes referred to as a “cloud” computing environment). Certain data described herein may optionally be stored using a data store that may comprise a hosted storage environment that includes a collection of physical data storage devices that may be remotely accessible and may be rapidly provisioned as needed (sometimes referred to as “cloud” storage). Optionally, some or all of the LLM system 104 functionality may be incorporated into the user device 110.

The LLM system 104 may ingest vast amounts of text content and optionally image and sound content from a large variety of sources (e.g., webserver 106, database 108, or the like) including webpages, books, magazines, articles, and other publications. Such data may be used to train the LLM system 104 (e.g., using an unsupervised or supervised learning approach). The LLM system 104 may access such content from corresponding systems over a network 102 (e.g., the Internet, an intranet, a wide area network, etc.).

Optionally, the LLM system 104 may utilize natural language processing (NLP) to extract keywords, sentiment analysis to determine the mood, and/or semantic parsing to extract the structure of the input text.

As similarly discussed elsewhere herein, the LLM engine may optionally be configured with a genetic algorithm configured to optimize the hyperparameters and/or other aspects of large language models. The LLM engine may optionally be configured to receive a fitness function (option in free form text) from a user via a user interface or from another system or a data file.

The LLM system 104 may communicate with one or more user devices 110 (e.g., a computing device, such as a smartphone, a desktop computer, a laptop computer, a tablet, a smart television, a game console, a smart watch or other wearable, and/or the like) over the network 102. For example, the LLM system 104 may provide one or more user interfaces (e.g., in a webpage or an application) via which a user may enter queries and/or fitness functions. The queries and/or fitness functions entered (e.g., via a keyboard, voice, or otherwise) by the user into corresponding user interface fields may be transmitted from the user device 110 to the LLM system 104. The LLM system 104 may in turn generate response(s) to the user query that satisfy the user-specified fitness function and transmit the response(s) to the user device 110, which may display and/or read out the response(s) to the user. Optionally, the user may enter the fitness function using free form text. Optionally, the user interface includes a control that enables the user to specify a maximum number of LLM response generation attempts that are to be made in response to the user query.

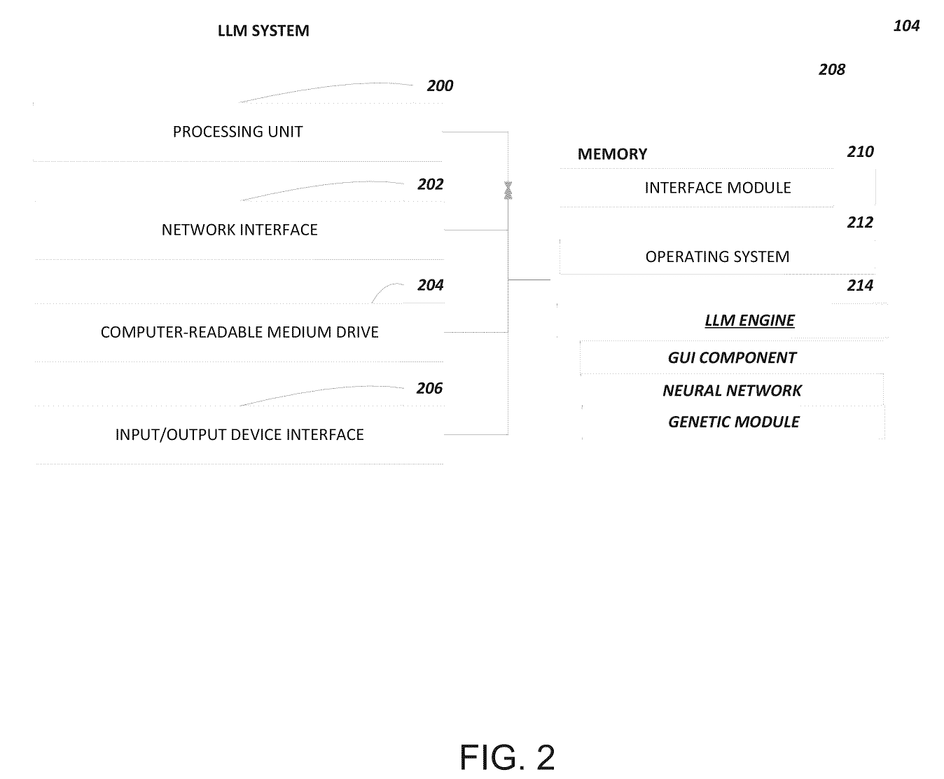

FIG. 2 is a block diagram illustrating example components of the LLM system 104. The example LLM system 104 includes an arrangement of computer hardware and software components that may be used to implement aspects of the present disclosure. Those skilled in the art will appreciate that the example components may include more (or fewer) components than those depicted in FIG. 2. Optionally, computer hardware and/or software components illustrated in FIG. 2 may be instead or also be included in other systems depicted in FIG. 1.

The LLM system 104 may include one or more processing units 200 (e.g., one or more general purpose processors and/or high speed graphics processors), one or more network interfaces 202, a non-transitory computer-readable medium drive 204, and an input/output device interface 206, all of which may communicate with one another by way of one or more communication buses. The network interface 202 may provide services described herein with connectivity to one or more networks or computing systems (e.g., LLM systems, webservers, user devices, etc.). The processing unit 200 may thus receive models and/or information (e.g., LLM models, webpages, other content used to train the LLM models, etc.), and/or instructions from other computing devices, systems, or services via a network, and may provide responsive data and/or execute instructions. The processing unit 200 may also communicate data to and from memory 204 and further provide output information via the input/output device interface 206. The input/output device interface 206 may also accept input from one or more input devices, such as a keyboard, mouse, digital pen, touch screen, microphone, camera, etc.

The memory 208 may contain computer program instructions that the processing unit 200 may execute in order to implement one or more aspects of the present disclosure. The memory 208 generally includes RAM, ROM (and variants thereof, such as EEPROM) and/or other persistent or non-transitory tangible computer-readable storage media. An interface module 210 may provide access to data in the memory 208 and may enable data to be stored in the memory 208. The memory 208 may store an operating system 212 that provides computer program instructions for use by the processing unit 200 in the general administration and operation of an LLM engine 214, including its components.

The memory 208 may store user data, such as user credentials, user preferences with respect to the generation of LLM responses (e.g., user specified number of attempts, saved fitness functions, etc.), a history of queries, query answers, and/or other content and data described herein.

Some or all of the data and content discussed herein may optionally be stored in a relational database, an SQL database, a NOSQL database, or other database type. Optionally, the memory 208 may include one or more external third party cloud-based storage systems.

The LLM engine 214 may include a GUI component that generates graphical user interfaces and processes user inputs (e.g., LLM queries and/or fitness functions, maximum number of response attempts, and/or other user inputs described herein) and an LLM (e.g., comprising a neural network, such as an encoder-decoder recurrent neural network or a transfer network) configured to generate and/or select content to present to the user. The LLM may be trained using some or all of the data described herein and/or other data.

Optionally, the LLM engine 214 may comprise a transformer architecture that utilizes self-attention, which enables the model to selectively focus on different parts of the input sequence during the encoding process. The transformer architecture may comprise an encoder and a decoder, connected through a one or more multi-head attention and feedforward layers.

The encoder is configured to receive an input sequence and process it using multi-head self-attention, where the input sequence is transformed into a set of query, key, and value vectors. The query, key, and value vectors may be used to compute the attention scores between given positions in the sequence, enabling the model to identify the relevant (e.g., most relevant) portions of the input sequence for respective positions.

The decoder is configured to receive the encoder output and generate an output sequence. The decoder may also utilize multi-head attention, and may be further configured with an additional attention mechanism that enables the decoder to attend to the encoder output and to generate the output sequence using the relevant information from the input sequence. For example, an attention module may repeat its computations several times in parallel, which may be referred to as respective attention heads. Optionally, the attention module splits Query, Key, and Value parameters N-ways and passes each, independently, through a separate attention head.

The transformer architecture may comprise one or more feedforward layers, which apply a linear transformation followed by a non-linear activation function to the output of the attention layers. The feedforward layers facilitate further capture patterns in the input and output sequences.

The transformer may comprise a loss function that measures the difference between the predicted output sequence and the true output sequence. The transformer is configured to minimize or reduce the loss function output. Backpropagation may be utilized as part of the minimization process, where the gradients of the loss function with respect to the model parameters are calculated and used to update the model weights (e.g., associated with neural network layers).

The LLM engine 214 may include a genetic module. As discussed herein, the genetic module may comprise an executable genetic algorithm. Genetic algorithms can be used to optimize the hyperparameters of large language models, which can improve their output performance. The genetic algorithms may be utilized to otherwise optimize various aspects of the LLM engine 214.

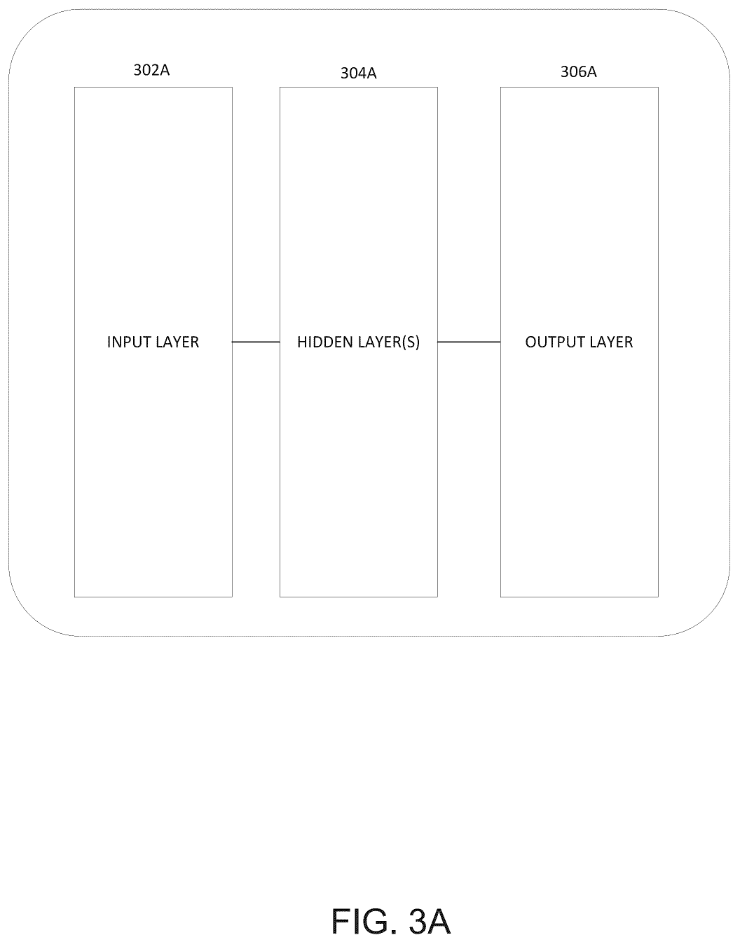

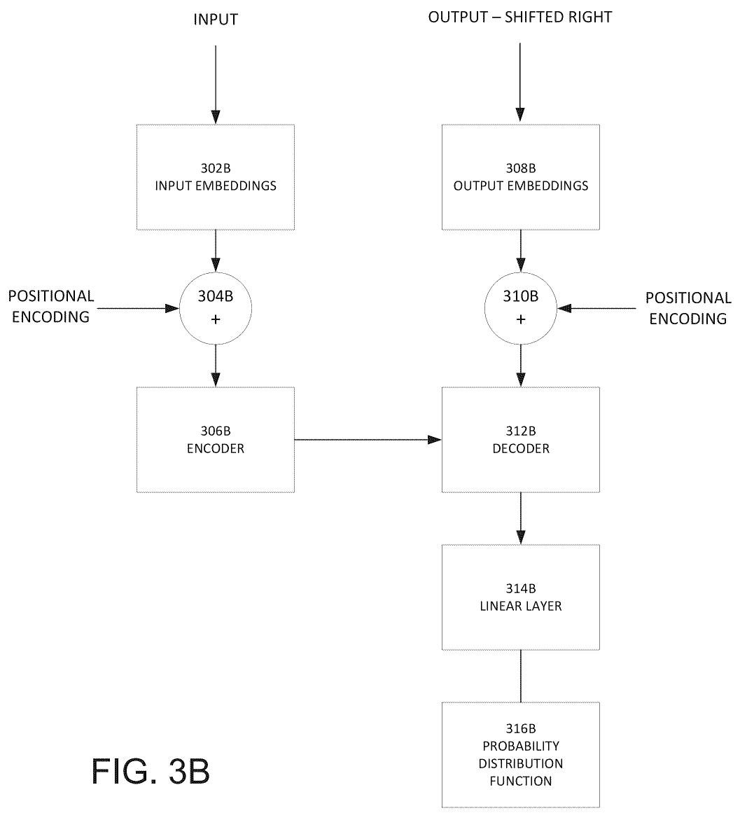

An example of a neural network configured to generate response to user queries in accordance with a fitness function, such as that described herein, is illustrated in FIG. 3A. The neural network may contain an input layer 302A, one or more hidden layers 304A, and an output layer 306A. The hidden layers 304A may be configured as convolutional layers, pooling layers, fully connected layers and/or normalization layers. For example, the neural network may be configured with one or more pooling layers that combine outputs of neuron clusters at one layer into a single neuron in the next layer. Max pooling and/or average pooling may be utilized. Max pooling may utilize the maximum value from each of a cluster of neurons at the prior layer. Average pooling may utilize the average value from each of a cluster of neurons at the prior layer.

The training data may comprise data scraped from one or more websites, from one or more databases, or may be obtained from other sources. The neural network may be trained based using a supervised or unsupervised process. The neural network layer node weights may be adjusted using backpropagation based on an error function output with respect to the accuracy/relevance of the content generated and/or selected by the neural network, to thereby lower the error.

A transformer model may be utilized to generate and/or select content for a user. Referring now to FIG. 3B, an example transformer model architecture is illustrated.

Block 302B is configured to receive tokens (a sequence of characters or subwords that represent a single unit of meaning within the input text) and generate input embeddings, where the input text is converted into a numerical format, sometimes referred to as input embeddings. The input embeddings represent words as numbers so as to be suitable for machine learning model processing. During training, the model learns how to create such embeddings so that similar vectors represent words with similar meanings.

Positional encoding may be utilized to encode the position of a given word in the input sequence as a set of numbers. The set of numbers may be input to transformer model 304B, in association with the input embeddings, to enable the model to understand the order of words in a sentence and generate grammatically correct and semantically meaningful output.

A neural network encoder 306B processes the received text and generates a series of hidden states that encapsulate the text context and the text meaning and that represent the input text at different levels of abstraction. Optionally, there may be a plurality of encoder layers. Optionally, the encoder tokenizes the input text into a sequence of tokens (e.g., words or sub-words), and applies one or more serial attention layers, such as individual words or sub-words. Advantageously, such attention layers enable the transformed model to selectively focus on different parts of the input sequence rather than having to treat each word or sub-word the same way, and further advantageously, enables relationships between inputs significantly distanced apart in the sequence to be determined. Such determined relationships facilitate language processing tasks.

The decoder 312B may be trained to predict a next word in a text sequence based on the prior words. This is optionally performed in part by shifting the output sequence to the right so that the decoder is only using the earlier words.

The output is converted to a numerical format, which may be referred to as output embeddings 308B. Positional encoding is optionally performed to facilitate the transformer model understanding of the order of words in a segment (e.g., a sentence). The set of numbers may be input 310B. A loss function, configured to calculate the difference between the transformer model's predictions and the actual values, may be utilized to adjust the transformer model to improve accuracy by reducing the difference between predictions and targets, and hence the error. During training, the output embeddings may compute the loss function and update the transformer model parameters to improve the transformer model performance. During an inference process, the output embeddings may generate output text by mapping the model's predicted probabilities of a given token to the corresponding token in the vocabulary.

The decoder 312B may receive the positionally encoded input representation and the positionally encoded output embeddings and, based on the foregoing, generates an output sequence. There may be one or more layers of decoders 312B. During the training process, the decoder learns how to predict the next word by examining the prior words. The decoder 312B may generate natural language text based on the input sequence and the context learned by the encoder.

A linear layer 314B may map the output embeddings from the decoder 312B to a higher-dimensional space to thereby transform the output embeddings from the decoder 312B into the original input space. A probability distribution function, 316B, such as the softmax function, may be applied to the output of the model's final layer, producing a vector of scores representing the likelihood of each possible output token in the vocabulary given the input sequence. The function may map these scores to a probability distribution over the vocabulary, with higher scores corresponding to higher probabilities.

By converting the output of the model into a probability distribution, the probability distribution function enables the transformer model to produce a prediction for the next token that is both informed by the input sequence and consistent with the language's syntax and semantics. This allows the model to generate fluent, coherent text that reflects the structure and style of the input text.

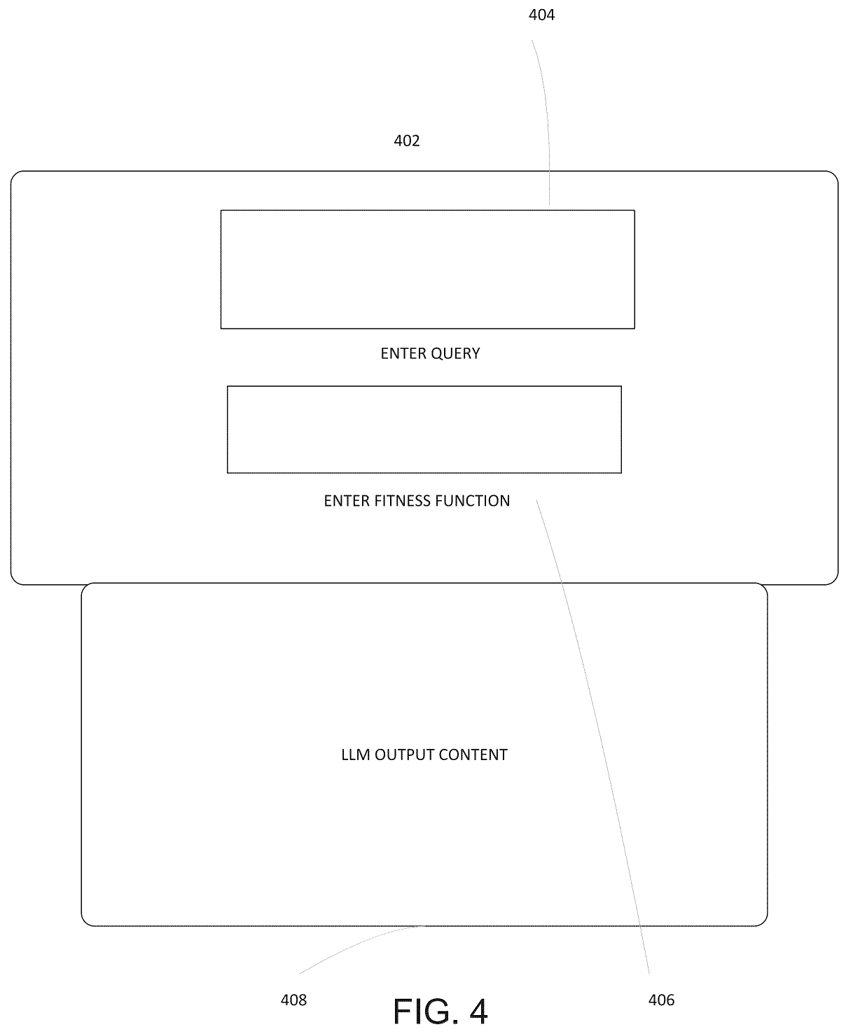

Referring now to FIG. 4, an example user interface 402 is presented. The user interface may be provided via a webpage or application (optionally downloaded to and) hosted on a user device. The user interface 402 includes a query entry field 404 configured to receive a user query to be submitted to a large language model. The user interface 402 also includes a fitness function entry field 406, configured to receive a fitness function (optionally in free form text) from the user to be submitted to the large language model. Field 408 may present the output of the LLM generated in response to the user query and fitness function.

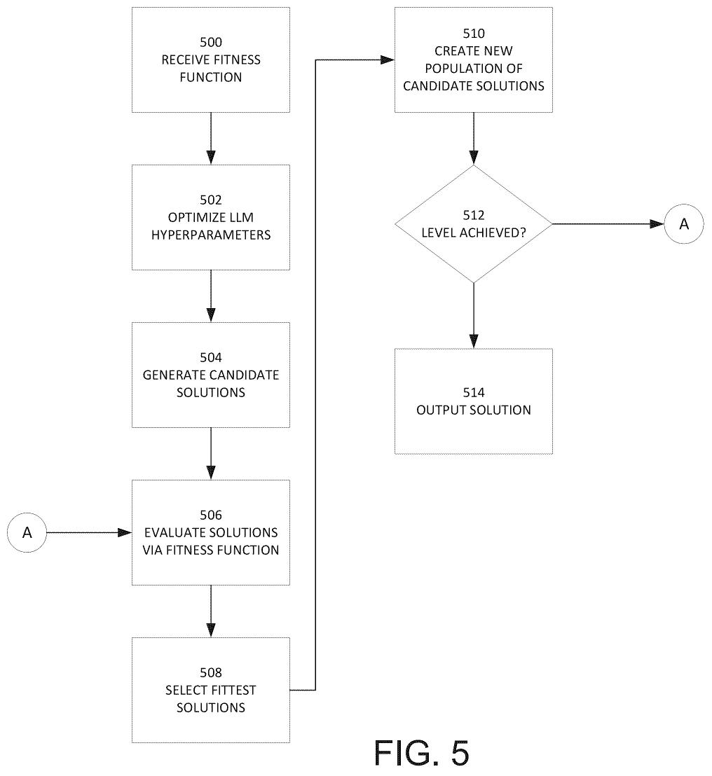

Referring now to FIG. 5, an example process is illustrated. At block 500, a fitness function is received from a user. For example, the fitness function may be received via a fitness function field presented on a user device via a webpage hosted on an LLM web server and presented via a general purpose browser hosted on the user device or a dedicated application downloaded to and hosted on the user device. Optionally, the user interface may be presented via an application downloaded from an application store to the user device. By way of illustrative example, the fitness function may be provided by a user via free form text.

At block 502, the large language model hyperparameters to be optimized and their possible values are defined. For example, the hyperparameters may optionally include the learning rate, the number of layers, the batch size, the dropout rate, and/or other hyperparameters that can affect the performance of the large language model.

At block 504, an initial population of candidate solutions is generated (e.g., using a large language model, randomly, using heuristics, or otherwise) where a given solution corresponds to a set of hyperparameters.

At block 506, the fitness function is evaluated with respect to the candidate solutions. As discussed above, the fitness function is a measure of how well (e.g., the perplexity or the accuracy) the candidate solution performs on the task at hand.

At block 508, the fittest solutions are selected based on their fitness score. These solutions will form the basis for the next generation.

At block 510, genetic operators (e.g., crossover, mutation, and/or selection) are applied to the selected solutions to create a new population of candidate solutions.

At block 512, a determination is made as to whether the desired level of performance is achieved. If the desired level of performance is achieved, the process may end, and at block 514 the fittest solution(s) may be output to the user. For example, the solution (or solutions) may be transmitted over a network to the user device for reproduction by a display (e.g., which may display the solutions) and/or a speaker (e.g., which may audibly speak the solution). If the desired level of performance is not yet achieved, the process may be repeated for multiple generations until the desired level of performance is achieved or until a threshold number of attempts have been made.

Thus, an aspect of the present disclosure relates to a computer system associated with a user, the computer system comprising: a network interface; at least one processing device operable to: receive a user query via the network interface, from a user device; receive fitness function; generate, using a large language model, candidate solutions to the user query; evaluate candidate solutions using the fitness function; use a genetic algorithm to generate, based at least in part on the evaluations of candidate solutions, a population of candidate solutions; evaluate the population of candidate solutions using the fitness function; based at least in part on the evaluation of the population of candidate solutions, transmit, via the network interface, at least a portion of the population of candidate solutions to the user device for reproduction via a user device display and/or a speaker.

Optionally, the system is operable to, based at least in part on the evaluation of the population of candidate solutions, using the fitness function, that indicates that the population of candidate solutions does not contain at least one suitable solution, generate another population of candidate solutions. Optionally, the system is operable to optimize one or more large language model hyperparameters, comprising learning rate, number of layers, number of neurons, dropout rate, and/or batch size. Optionally, the system is operable to optimize one or more large language model hyperparameters using at least one genetic algorithm. Optionally, the user query and the fitness function are receivable via respective webpage fields respectively configured to receive the user query and the fitness function at the user device. Optionally, the system is operable to modify the user query in generating the population of candidate solutions. Optionally, the large language model comprises an input layer, an output layer, one or more hidden layers, and a max pooling layer.

An aspect of the present disclosure relates to a computer-implemented method, the method comprising: receiving a user query over a network, from a user device; receiving a fitness function; generating, using a large language model, candidate solutions to the user query; evaluating candidate solutions using the fitness function; using a genetic algorithm to generate, based at least in part on the evaluations of candidate solutions, a population of candidate solutions; evaluating the population of candidate solutions using the fitness function; based at least in part on the evaluation of the population of candidate solutions, transmitting, over the network, at least a portion of the population of candidate solutions to the user device for reproduction via a user device display and/or a speaker.

Optionally, the method further comprising, based at least in part on the evaluation of the population of candidate solutions, using the fitness function, that indicates that the population of candidate solutions does not contain at least one suitable solution, generating another population of candidate solutions. Optionally, the method further comprising optimizing one or more large language model hyperparameters comprising learning rate, number of layers, number of neurons, dropout rate, and/or batch size. Optionally, the method further comprising optimizing one or more large language model hyperparameters using at least one genetic algorithm. Optionally, wherein the user query and the fitness function are receivable via respective webpage fields respectively configured to receive the user query and the fitness function at the user device. Optionally, the method further comprising using a modified user query in generating the population of candidate solutions. Optionally, the large language model comprises an input layer, an output layer, one or more hidden layers, and a max pooling layer.

An aspect of the present disclosure relates to a computer-readable, non-transitory medium that stores program instructions that when executed by a computer system, cause the computer system to perform operations comprising: receive a user query, from a user device; receive fitness function; generate, using a large language model, candidate solutions to the user query; evaluate candidate solutions using the fitness function; use a genetic algorithm to generate, based at least in part on the evaluations of candidate solutions, a population of candidate solutions; evaluate the population of candidate solutions using the fitness function; and based at least in part on the evaluation of the population of candidate solutions, transmit at least a portion of the population of candidate solutions to the user device for reproduction.

Optionally, the operations further comprise: based at least in part on the evaluation of the population of candidate solutions, using the fitness function, that indicates that the population of candidate solutions does not contain at least one suitable solution, generate another population of candidate solutions. Optionally, the operations further comprise: optimize one or more large language model hyperparameters, comprising learning rate, number of layers, number of neurons, dropout rate, and/or batch size. Optionally, the operations further comprise: optimize one or more large language model hyperparameters using at least one genetic algorithm. Optionally, the user query and the fitness function are receivable via respective webpage fields respectively configured to receive the user query and the fitness function at the user device. Optionally, the operations further comprise: modify the user query in generating the population of candidate solutions. Optionally, the large language model comprises an input layer, an output layer, one or more hidden layers, and a max pooling layer.

Thus, methods and systems are described that provide enhanced large language model performance and optimization. Optionally, a genetic algorithm may be utilized to optimize the performance of the large language model.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources, or may comprise a standalone system. Two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone or mobile application, computer application, a short messaging service message (e.g., SMS, MMS, etc.), instant messaging, email, push notification, audibly, via haptic feedback, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, microphone, camera, touch pad, etc.), network interfaces, etc.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. § 112 (f) will begin with the words “means for,” but use of the term “for” in any other context is not intended to invoke trea 104tment under 35 U.S.C. § 112 (f). Accordingly, the applicant reserves the right to pursue additional claims after filing this application, in either this application or in a continuing application.

What is claimed is:

1. A computer system associated with a user, the computer system comprising:
a network interface;
at least one processing device operable to:
receive a user query via the network interface, from a user device;
receive fitness function;
generate, using a large language model, candidate solutions to the user query;
evaluate candidate solutions using the fitness function;
use a genetic algorithm to generate, based at least in part on the evaluations of candidate solutions, a population of candidate solutions;
evaluate the population of candidate solutions using the fitness function; and
based at least in part on the evaluation of the population of candidate solutions, transmit, via the network interface, at least a portion of the population of candidate solutions to the user device for reproduction via a user device display and/or a speaker.

2. The computer system as defined in claim 1, wherein the system is operable to, based at least in part on the evaluation of the population of candidate solutions, using the fitness function, that indicates that the population of candidate solutions does not contain at least one suitable solution, generate another population of candidate solutions.

3. The computer system as defined in claim 1, wherein the system is operable to optimize one or more large language model hyperparameters, comprising learning rate, number of layers, number of neurons, dropout rate, and/or batch size.

4. The computer system as defined in claim 1, wherein the system is operable to optimize one or more large language model hyperparameters using at least one genetic algorithm.

5. The computer system as defined in claim 1, wherein the user query and the fitness function are receivable via respective webpage fields respectively configured to receive the user query and the fitness function at the user device.

6. The computer system as defined in claim 1, wherein the system is operable to modify the user query in generating the population of candidate solutions.

7. The computer system as defined in claim 1, wherein the large language model comprises an input layer, an output layer, one or more hidden layers, and a max pooling layer.

8. A computer-implemented method, the method comprising:
receiving a user query over a network, from a user device;
receiving a fitness function;
generating, using a large language model, candidate solutions to the user query;
evaluating candidate solutions using the fitness function;
using a genetic algorithm to generate, based at least in part on the evaluations of candidate solutions, a population of candidate solutions;
evaluating the population of candidate solutions using the fitness function; and
based at least in part on the evaluation of the population of candidate solutions, transmitting, over the network, at least a portion of the population of candidate solutions to the user device for reproduction via a user device display and/or a speaker.

9. The computer-implemented method system as defined in claim 8, the method further comprising, based at least in part on the evaluation of the population of candidate solutions, using the fitness function, that indicates that the population of candidate solutions does not contain at least one suitable solution, generating another population of candidate solutions.

10. The computer-implemented method system as defined in claim 8, the method further comprising optimizing one or more large language model hyperparameters comprising learning rate, number of layers, number of neurons, dropout rate, and/or batch size.

11. The computer-implemented method system as defined in claim 8, the method further comprising optimizing one or more large language model hyperparameters using at least one genetic algorithm.

12. The computer-implemented method system as defined in claim 8, wherein the user query and the fitness function are receivable via respective webpage fields respectively configured to receive the user query and the fitness function at the user device.

13. The computer-implemented method system as defined in claim 8, the method further comprising using a modified user query in generating the population of candidate solutions.

14. The computer-implemented method system as defined in claim 8, wherein the large language model comprises an input layer, an output layer, one or more hidden layers, and a max pooling layer.

15. A computer-readable, non-transitory medium that stores program instructions that when executed by a computer system, cause the computer system to perform operations comprising:
receive a user query, from a user device;
receive fitness function;
generate, using a large language model, candidate solutions to the user query;
evaluate candidate solutions using the fitness function;
use a genetic algorithm to generate, based at least in part on the evaluations of candidate solutions, a population of candidate solutions;
evaluate the population of candidate solutions using the fitness function; and
based at least in part on the evaluation of the population of candidate solutions, transmit at least a portion of the population of candidate solutions to the user device for reproduction.

16. The computer-readable, non-transitory medium as defined in claim 15, the operations further comprising: based at least in part on the evaluation of the population of candidate solutions, using the fitness function, that indicates that the population of candidate solutions does not contain at least one suitable solution, generate another population of candidate solutions.

17. The computer-readable, non-transitory medium as defined in claim 15, the operations further comprising: optimize one or more large language model hyperparameters, comprising learning rate, number of layers, number of neurons, dropout rate, and/or batch size.

18. The computer-readable, non-transitory medium as defined in claim 15, the operations further comprising: optimize one or more large language model hyperparameters using at least one genetic algorithm.

19. The computer-readable, non-transitory medium as defined in claim 15, wherein the user query and the fitness function are receivable via respective webpage fields respectively configured to receive the user query and the fitness function at the user device.

20. The computer-readable, non-transitory medium as defined in claim 15, the operations further comprising: modify the user query in generating the population of candidate solutions.

21. The computer-readable, non-transitory medium as defined in claim 15, wherein the large language model comprises an input layer, an output layer, one or more hidden layers, and a max pooling layer.
